(19) United States
(12) Patent Application Publication
(10) Pub. No.: US 2023/0334232 A1
(43) Pub. Date: Oct. 19, 2023

(54) PROMPTING DOCUMENT SHARING BETWEEN COLLABORATING USERS

(71) Applicant: Hewlett-Packard Development Company, L.P., Spring, TX (US)

(72) Inventor: Rafael Dal Zotto, Spring, TX (US)

(73) Assignee: Hewlett-Packard Development Company, L.P., Spring, TX (US)

(21) Appl. No.: 18/042,939

(22) PCT Filed: Aug. 31, 2020
(86) PCT No.: PCT/US2020/048694

§ 371 Date: Feb. 24, 2023

(51) Int. Cl. G06F 40/166; G06F 16/176; G06F 16/17

(52) U.S. Cl. CPC G06F 40/166; G06F 16/176; G06F 16/1734

(57) ABSTRACT

Examples are described herein for providing document suggestions to a group of collaborating users. In various examples, based on input provided by a first user, it may be determined that the first user intends to collaborate with a second user remotely. Based on a knowledge graph that defines relationships between users, documents, and applications usable to open the documents, a document or application may be identified that is commonly associated with both the first user and the second user. A prompt to share access with the second user to the commonly associated document or a new document compatible with the commonly associated application may be provided via a computing device of the first user.

### BACKGROUND

The modern workplace is changing rapidly as an increasing number of office employees are working from home, distributed across different geographic locations. These employees are therefore increasingly relying on collaboration tools to assist teams of employees in sharing and collaborating on multiple documents and files. These documents and files are often created using different took, applications, and programs developed by various providers. Moreover, many of these documents and files will have several versions edited by several different employees over time. This can make it difficult for employees to quickly identify which is the correct or most suitable document version or online link to share with their colleagues with whom they wish to collaborate.

### BRIEF DESCRIPTION OF THE DRAWINGS

The present application may be more fully appreciated in connection with the following detailed description taken in conjunction with the accompanying drawings.

FIG. 1 illustrates an example environment in which aspects of the present disclosure may be implemented.

FIG. 2 illustrates an example of a knowledge graph maintained by a document recommendation system, in accordance with an example of the present disclosure.

FIG. 3 illustrates another example of a knowledge graph maintained by a document recommendation system, in accordance with an example of the present disclosure.

FIGS. 4A and 4B illustrate an example of a document recommendation system utilizing the knowledge graph of FIG. 3 to provide a document suggestion to two collaborating users, in accordance with an example of the present disclosure.

FIGS. 5A and 5B illustrate an example of a document recommendation system utilizing the knowledge graph of FIG. 3 to provide a document suggestion to three collaborating users, in accordance with an example of the present disclosure.

FIGS. 6A and 6B illustrate an example of a document recommendation system utilizing the knowledge graph of FIG. 3 to provide multiple document suggestions to three collaborating users, in accordance with an example of the present disclosure.

FIG. 7 is a flow diagram that illustrates an example method, in accordance with an example of the present disclosure.

FIG. 8 illustrates an example system performing an example process, in accordance with an example of the present disclosure.

FIG. 9 schematically depicts an example machine readable medium with a processor, in accordance with an example of the present disclosure.

### DETAILED DESCRIPTION

Examples described herein enable easier collaboration between employees or other teams of users by quickly finding suitable documents to be shared with a given audience. The system can collect, aggregate, and organize data indicating user creation, modification, and sharing of documents to form a collaboration knowledge graph. The collaboration knowledge graph can then be used to effectively and efficiently provide recommendations of documents, document links, and document versions most appropriate for a user to share with their target audience.

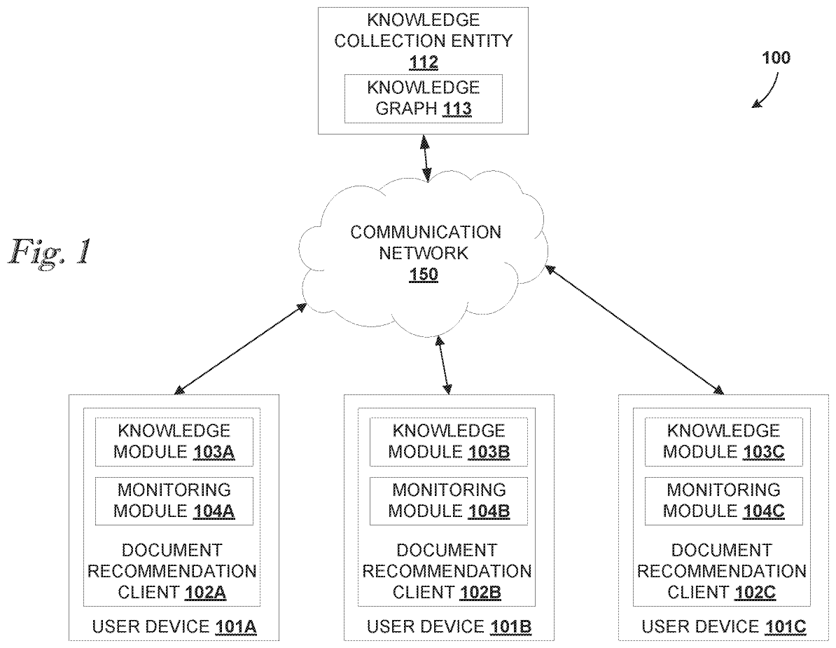

FIG. 1 illustrates an example environment in which aspects of the present disclosure may be implemented. FIG. 1 includes three user devices, 101A, 101B, and 101C. The user devices 101A, 101B, 101C have respective document recommendation client applications 102A, 102B, 102C installed. Document recommendation client applications 102A, 102B, 102C may include respective knowledge modules 103A, 103B, and 103C, and respective monitoring modules 104A, 104B, and 104C. The document recommendation client applications 102A, 102B, 102C installed on the user devices 101A, 1018, 101C communicate with a knowledge collection entity 112 that includes a knowledge graph 113 over a communication network 150. For the sakes of brevity and simplicity, components 101-104 will be referred to without their suffix letters unless a specific component is being described.

The knowledge collection entity 112 may be a part of the backend infrastructure of the document recommendation client application 102 and may be hosted on a server, or on multiple remote servers forming what is often referred to as a “cloud” infrastructure or simply “the cloud.” The server hosting the knowledge collection entity 112 may maintain and update the knowledge graph 113 describing interactions between multiple users and multiple documents via the user devices 101A, 101B, 101C. In some examples, the knowledge collection entity 112 may be a part of or may have access to the backend file system infrastructure of an enterprise of which users associated with the user devices 101A, 101B, 101C are employees.

The document recommendation client applications 102A-C and the backend infrastructure of the document recommendation client applications 102A-C together make a document recommendation system 100. The document recommendation system 100 maintains a knowledge graph 113 of user interactions with documents and to suggest documents for groups of users to collaborate on based on the knowledge contained in the knowledge graph 113.

The monitoring modules 104A, 104B, 104C may monitor user manipulation, including creation and modification, of documents on the respective user devices 101A, 101B, 101C. In some examples, the monitoring modules 104A, 104B, 104C may additionally monitor users opening and reviewing documents as well as sharing copies of documents or links to access documents. Although depicted in FIG. 1 as implemented by the user devices 101A, 101B, 101C, in some examples, all or portions of the monitoring modules 104A, 104B, 104C may be implemented in whole or in part on the knowledge collection entity 112.

The monitoring modules 104A, 104B, 104C may generate metadata characterizing user interactions with documents identified on the user devices 101A, 101B, 101C and may send this metadata to the respective associated knowledge modules 103A, 103B, 103C. The knowledge modules 103A, 103B, 103C may communicate with the knowledge collection entity 112 that includes the knowledge graph 113 over the communication network 150, for example through an application programming interface (“API”). The communications between the knowledge modules 103A, 103B, 103C and the knowledge collection entity 112 may include knowledge modules 103A, 103B, 103C providing metadata generated by the monitoring modules 104A, 104B, 104C to the knowledge collection entity 112 and requesting information from the knowledge graph 113 from the knowledge collection entity 112.

The monitoring modules 104A, 104B, 104C may select a default group of software applications and collaborative online tools and services associated with user creation, modification, viewing, and/or sharing of documents (herein “document access programs”). The default group of document access programs to be monitored may be set by personnel of an enterprise associated with the user devices 101A, 101B, 101C of employees, may be set by each user upon installation of the document recommendation client application on their respective user devices 101A, 101B, 101C, or may be set by the developer of the document recommendation client application 102.

In some examples, the monitoring modules 104A, 104B, 104C may customize the default group of document access programs to be monitored for a particular user or for particular groups of users. For example, the monitoring module 104A may add document access PROGRAM A to a list of document access programs to be monitored for a particular user associated with user device 101A based on determining that the particular user has sent an electronic communication, such as an email, to a colleague with a document attached that was created in PROGRAM A. As another example, the monitoring modules 104B and 104C may remove default document access PROGRAM X from a list of document access programs to be monitored for the users associated with user devices 101B and 101C, and associated with a particular enterprise department designation, based on determining that the group of users within that enterprise department never create, modify, or share, documents using PROGRAM X.

Such customization of the default group of document access programs to be monitored for particular users may conserve system and network resources that would otherwise be used to monitor user access of each and every file accessible to the users. In some examples the user may be able to further specify which document access programs should and should not be monitored by the monitoring modules 104A, 104B, 104C. In some examples, the default configuration may be to monitor all document access programs installed on computing devices of users and/or known to be commonly used for document creation, modification, viewing, and/or sharing by the monitoring modules 104A, 104B, 104C. In such examples, the user may be prompted to customize their own list of document access programs to be monitored, switch to monitoring of the default document access programs, or continue monitoring all document access programs known to the monitoring modules 104A, 104B, 104C.

The monitoring modules 104A, 104B, 104C may use the list of document access programs to be monitored to observe the new instances of document access via the user devices 101A, 101B, 101C. In some examples, monitoring for document access includes monitoring for document creation or modification. In some examples, monitoring for document access further includes monitoring for document viewing or sharing. The list of document access programs may also include online collaborative tools and services and, in this case, the monitoring modules 104A, 104B, 104C may observe the browser history of the user devices 101A, 101B, 101C to identify new instances of document access by users of the user devices 101A, 101B, 101C.

Each time a new instance of access of a document is identified, the monitoring modules 104A, 104B, 104C may determine a document identifier for the document accessed, a user identifier for the user who accessed the document, and a timestamp that describes when the document access occurred. The monitoring modules 104A, 104B, 104C may use the timestamp and the identifiers to generate metadata used to trigger an update a knowledge graph that organizes information describing enterprise user interactions with documents.

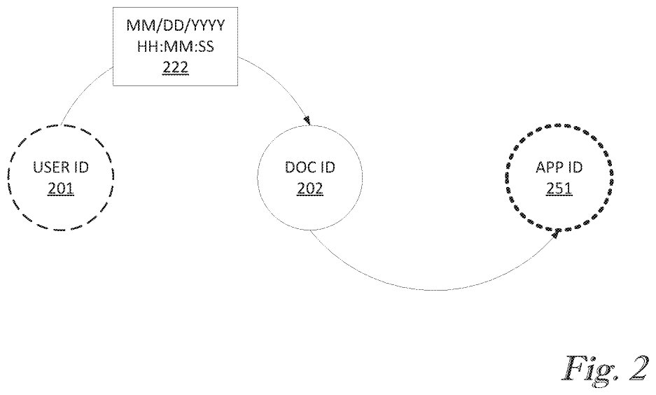

FIG. 2 illustrates an example of a knowledge graph maintained by a document recommendation system, in accordance with an example of the present disclosure. The document recommendation system of FIG. 2 may be the document recommendation system 100 of FIG. 1.

In the example of FIG. 2, a user has accessed a document using an application that is being monitored by a monitoring module of the document recommendation client application installed on their user device, such as one of monitoring modules 104A, 104B, 104C of the document recommendation client applications 102A, 102B, 102C installed on the user devices 101A, 101B, 101C, respectively. Based on identifying this interaction, the monitoring module 104 may determine the User ID 201 of the user who created the document, the Document ID 202 of the created document, and the date and time when the user accessed the document. Based on identifying the user access of the document and determining the User ID 201, the Document ID 202, and the date and time when the user created the document, the monitoring module 104 may generate metadata describing the document access interaction and provide it to a knowledge module 103 of the document recommendation client application 102, which may be one of the knowledge modules 103A, 103B, 103C of FIG. 1.

The knowledge module 103 may receive the metadata indicating the User ID 201, the Document ID 202, and the date and time of the user access of the document, and, in response, may communicate with a knowledge collection entity hosting a knowledge graph, such as the knowledge collection entity 112 hosting knowledge graph 113 of FIG. 1. The knowledge module 103 may request information from the knowledge collection entity 112 about the knowledge in the knowledge graph 113, and may provide the generated metadata along with a request to update the knowledge graph to the knowledge collection entity 112.

When the knowledge collection entity 112 receives the metadata generated by a monitoring module 104 along with a request to update the knowledge graph 113 from a knowledge module 103, the knowledge collection entity 112 may first determine which portions of the knowledge graph 113 are to be updated based on the information included in the metadata. For example, the knowledge collection entity 112 may determine that there is no existing node corresponding to the User ID 201 in the knowledge graph 113. This may occur when the user corresponding to the User ID 201 has manipulated a document via a monitored document access program for the first time. The knowledge collection entity 112 may determine that there is not already a node corresponding to the Document ID 202 in the knowledge graph 113. This may occur when the document corresponding to the Document ID 202 has just been accessed by a monitored user via a monitored document access program for the first time.

The knowledge collection entity 112 may determine that nodes corresponding to both the User ID 201 and the Document ID 202 already exist in the knowledge graph 113, but no edge exists that connects the two nodes. This may occur when the user corresponding to the User ID 201 has just accessed the document corresponding to the Document ID 202 for the first time, which was created by a different user corresponding to a different User ID node. The knowledge collection entity 112 may determine that nodes corresponding to the User ID 201 and the Document ID 202 already exist and are already connected by an edge of the knowledge graph 113. This may occur when a user corresponding to the User ID 201 has already accessed a document corresponding to the Document ID 202 in the past.

If the knowledge collection entity 112 determines that there is no existing Document ID 202 node, indicating that the new instance of user access corresponds to a user creation of a new document, then the knowledge collection entity 112 may access the backend file system infrastructure, may provide a request to a backend file system infrastructure server, or may provide a request to the monitoring module 104 that generated the metadata to determine an Application ID 251 associated with the document access program used to create the new document. Identified or received metadata indicating the Application ID 251 will then be used in updating the knowledge graph 113.

The knowledge collection entity 112 may update the knowledge graph 113 based on processing the metadata to determine the portions of the knowledge graph 113 that are to be updated, and optionally based on additional metadata describing the document access program used to create a new document. This may include adding new user nodes, adding new document nodes, adding new edges between new or existing user nodes and new or existing document nodes, updating existing edges between existing user nodes and existing document nodes, and adding new application nodes along with new edges connecting it to a new or existing document node. In some examples, updating the knowledge graph 113 may include storing some or all of the metadata describing the user interaction with the document in the knowledge graph 113.

In some examples, the knowledge collection entity 112 may update the knowledge graph 113 based on the information included in the timestamp, when triggered by the metadata from the monitoring module 104. This is because information describing any new instance of user access of documents generated by the monitoring module 104 may include new date and time information describing the user access.

Thus, the knowledge graph 113 may be updated as shown in FIG. 2 to include a node corresponding to the User ID 201, a node corresponding to the Document ID 202, and a node corresponding to the Application ID 251. Additionally, the knowledge graph may be updated to include edges connecting the User ID 201 to the Document ID 202 and connecting the Document ID 202 node to the Application ID 251 node. The edge connecting the Document ID 202 node to the Application ID 251 node may additionally include a Timestamp 222 indicating when the user associated with User ID 201 created the document using the program associated with Application ID 251.

Subsequent to updating the knowledge graph 113, the user corresponding to User ID 201 may modify the document corresponding to Document ID 202, using the program corresponding to Application ID 251 or using a different document access program. Based on identifying this new instance of user access, the monitoring module 104 may again generate metadata describing the interaction and provide it to the knowledge module 103 of the document recommendation client application 102.

Based on receiving the metadata indicating the interaction between the user and the document, the knowledge module 103 may trigger an update of the knowledge graph 113, for example by providing the metadata to the knowledge collection entity 112 hosting the knowledge graph 113 through an API. The update to the knowledge graph 113 may include updating the Timestamp 222 to indicate the date and time of the latest access of the document corresponding to Document ID 202 by the user corresponding to User ID 201.

If the document is modified and then saved as a new version of the document, then a new Document ID node corresponding to a document identifier of the new document version may additionally be included in the updated knowledge graph 113. If the new document version was created via a different document access program than the one corresponding to Application ID 251, then a new Application ID corresponding to the document access program used to create the new document version may additionally be included in the updated knowledge graph 113.

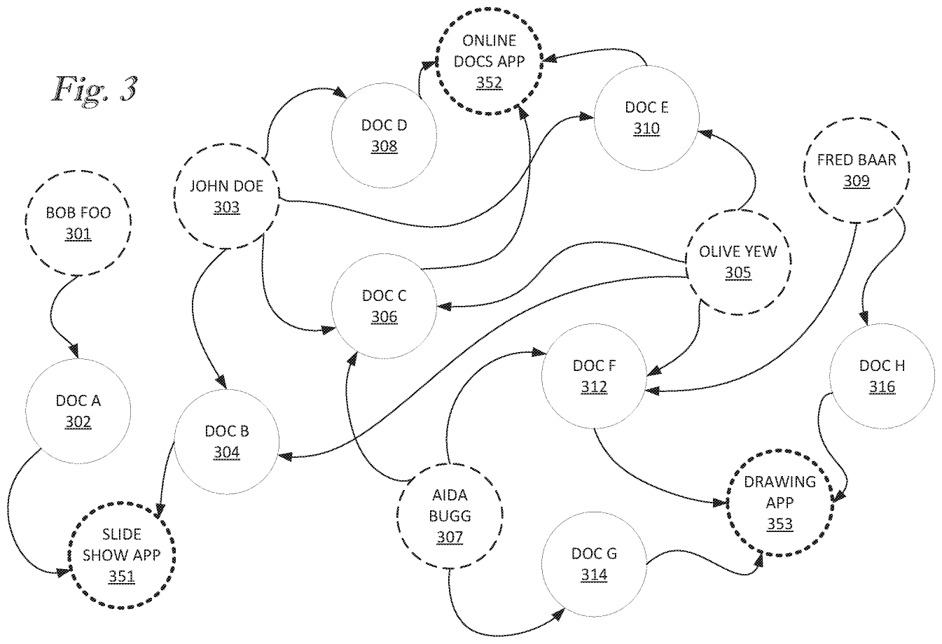

FIG. 3 illustrates another example of a knowledge graph maintained by a document recommendation system, in accordance with an example of the present disclosure. The document recommendation system of FIG. 3 may be the document recommendation system 100 of FIGS. 1 and 2. The knowledge graph 113 of FIG. 3 includes User ID nodes for users corresponding to Bob Foo 301, John Doe 303, Olive Yew 305, Aida Bugg 307, and Fred Baar 309, Document ID nodes for documents corresponding to DOC A 302, DOC B 304, DOC C 306, DOC D 308, DOC E 310, DOC F 312, DOC G 314, and DOC H 316, and Application ID nodes corresponding to Slide Show App 351, Online Docs App 352, and Drawing App 353.

While not shown in FIG. 3, edges between User ID nodes and Document ID nodes, such as the edge connecting the Bob Foo 301 node and the DOC A 302 node (represented in FIG. 3 as an arrow), may include timestamps such as the Timestamp 222 of FIG. 2 indicating when Bob Foo last accessed DOC A. In some examples, rather than being stored in the knowledge graph 113, the timestamps indicating when a particular user last accessed a particular document may be stored in a separate table or separate database and indications of the associations between users and documents on the knowledge graph 113 may instead include pointers to the corresponding timestamps.

Monitoring modules 104 local to user devices 101 of Bob Foo, John Doe, Olive Yew, Aida Bugg, and Fred Baar may monitor document access, including document creation and modification, for Bob Foo, John Doe, Olive Yew, Aida Bigg, and Fred Baar. In some examples, monitoring document access may additionally include monitoring viewing of documents and sharing of documents or links to documents.

As illustrated in FIG. 3, a monitoring module 104 may identify that John Doe has created DOC C using Online Docs App. The monitoring module may also identify that a link to access DOC C was later shared with Olive Yew, who accessed DOC C for review and collaboration. The monitoring module 104 may generate metadata characterizing these user interactions with documents and document access programs, and may provide the metadata to a knowledge module, such as the knowledge module 103 described with respect to FIGS. 1 and 2

The knowledge module 103 may then communicate with the knowledge collection entity 112 hosting the knowledge graph 113 to trigger an update to the knowledge graph 113 based on the metadata generated by the monitoring module 104. The knowledge collection entity 112 may receive the metadata generated by the monitoring module, access the knowledge graph 113, determine what updates to make to the knowledge graph 113 based on the metadata, and update the knowledge graph 113 accordingly.

With respect to the example of John Doe sharing a link to DOC C with Olive Yew 305, who then opens the link to DOC C and reviews DOC C, the update to the knowledge graph 113 will at the very least include updating the timestamp indicated by the edge connecting the Olive Yew 305 node to the DOC C 306 node (represented by an arrow) to reflect Olive Yew's most recent access of DOC C. In some examples, the update to the knowledge graph 113 will also include updating the timestamp indicated by the edge connecting the John Doe 303 node to the DOC C 306 node (represented by an arrow) to reflect the date and time when John Doe shared the link to DOC C with Olive Yew.

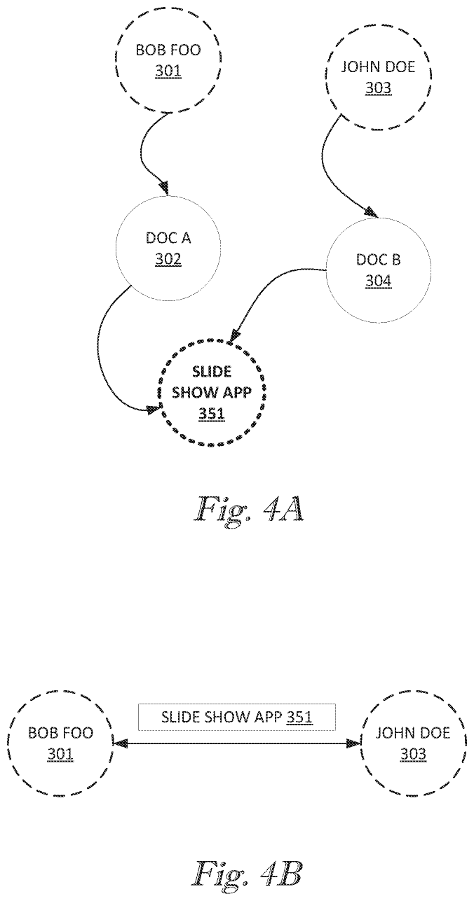

FIGS. 4A and 4B illustrate an example of a document recommendation system, such as the one described herein, using the knowledge graph of FIG. 3 to suggest documents and document access programs to users in order to facilitate their collaboration. The document recommendation system of FIGS. 4A and 4B may be the document recommendation system 100 of FIGS. 1, 2, and 3. The knowledge graph of FIGS. 4A and 4B may be the knowledge graph 113 of FIG. 3.

The knowledge graph 113 of FIGS. 3 and 4A enables quick collaboration between multiple users. A knowledge collection entity 112 of the document recommendation system 100 may traverse the knowledge graph 113 searching for document nodes that serve as a connection between nodes representing two or more of the multiple users. A document node that connects user nodes representing two or more of the users may correspond to a document that the users have accessed or to a document access program that of the users have used previously. Thus, the document recommendation system 100 may search the knowledge graph 113 for a node connecting two or more users, and suggest that a user share access to a particular document or a new document compatible with a particular application with other users with whom they are collaborating.

A monitoring module 104 of the document recommendation client application 102 installed locally on a user device 101 of a monitored user may determine that the user would like to collaborate on a document with other users. The monitoring module 104 may make this determination based on monitoring document access programs used for collaboration and/or based on monitoring local user access of both local and remote file systems.

For example, the monitoring module 104 may observe that the user is engaged, or intends to engage, in a digital collaboration environment with other monitored users when the user is engaged in, or takes steps to engage in, a remote video conference with the other users. As another example, the monitoring module may observe that the user has begun composing an email message directed to other users and has just selected or hovered their mouse over a “share”, “browse files”, or “attachment” button, or has accessed a file directory while composing the email.

Based on identifying that the user is engaged in a digital collaboration environment with other monitored users and identifying an indication that the user would like to collaborate with the other users on a document, the monitoring module 104 may generate metadata indicating user identifiers of the user and the other users and provide this metadata to the knowledge module 103 of the document recommendation client application 102. The knowledge module 103 may then generate and transmit a request for the knowledge collection entity 112 to search the knowledge graph 113 for user nodes corresponding to the user identifiers of the users. The knowledge collection entity 112 may respond to the search request with a document identifier or document access program identifier of the document or document access program node that connects the respective user nodes.

In examples where the knowledge collection entity 112 includes or has access to a backend file system infrastructure hosting a document corresponding to a document identifier, the knowledge collection entity 112 may additionally retrieve the document or a link to the document and provide it to the knowledge module 103 on the user device. In examples where the document identifier corresponds to a document hosted locally on a user device, the knowledge collection entity 112 may provide the document identifier to the knowledge module 103 of the user device and the knowledge module 103 or another module of the document recommendation client application 102 may responsively retrieve the document or a link to the document using its path locally.

When the document or document link corresponding to the document identifier is retrieved or received, the document recommendation client application 102 may then provide a suggestion to the user to share access to a particular document or to a new document created using a particular document access program with the other users, based on the document recommendation system 100 identifying the node connecting the users in the knowledge graph 113.

For example, the monitoring module 104 may monitor a remote video conferencing application installed on the user devices of Bob Foo and John Doe. The monitoring module 104 may identify that Bob Foo or John Doe, or both, has provided input to start a video conference with one another. Based on identifying this situation, the monitoring module 104 may determine that Bob Foo and John Doe wish to collaborate with one another. The monitoring module 104 may thereafter provide metadata indicating to the knowledge module 103 that a first user corresponding to a user ID of Bob Foo 301 and another user corresponding to another user ID of John Doe 303 wish to collaborate with one another.

The knowledge module 103 may generate a request for information from the knowledge graph 113 and provide the request to the knowledge collection entity 112 in response to receiving the metadata from the monitoring module 104. Receiving this indication from the knowledge module 103 may then trigger the knowledge collection entity 112 to traverse the knowledge graph 113 searching for a node connecting the Bob Foo 301 and John Doe 303 nodes.

The document recommendation system 100 may first search the knowledge graph of FIG. 4A for a document node connecting the Bob Foo 301 node to the John Doe 303 node. As shown in FIG. 4A, there is no document node commonly associated with both the Bob Foo 301 node and the John Doe 303 node in the knowledge graph 113. This will occur, for example, when Bob Foo and John Doe have not previously worked on the same document before. Based on determining that no document node connects the Bob Foo 301 and John Doe 303 nodes, the document recommendation system 100 may then search for a document access program node that is connected to both the Bob Foo 301 and John Doe 303 nodes through intermediary document nodes.

As shown in FIG. 4A, node DOC C 302 corresponding to a document previously worked on by Bob Foo and node DOC B 304 corresponding to a document previously worked on by John Doe were both created using a document access program corresponding to the Slide Show App 351 node. Thus, the DOC A 302 and DOC B 304 nodes are intermediary document nodes connecting the user nodes of Bob Foo 301 and John Doe 303 to the common node Slide Show App 351.

As shown in FIG. 4B, based on identifying this Slide Show App 351 node connecting the user nodes Bob Foo 301 and John Doe 303, the knowledge collection entity 112 may provide the application identifier of Slide Show App 351 to the knowledge modules 103A-C of both Bob Foo and John Doe's user devices. The knowledge modules 103A-C and/or other modules of the document recommendation client applications 102A-C installed on the user devices 101A-C may then cause the user devices of Bob Foo and John Doe to provide a prompt recommending the users share access to a new document created in the document access program corresponding to Slide Show App 351 with one another.

When a user affirmatively chooses to share access to the new document, the new document will be generated using the Slide Show App document access program and the new document, or a link to the new document, will be shared with the other user. The sharing of the document or a link to the document will occur either over the remote video conferencing application through which the users are collaborating, if it includes file sharing abilities, or through another application installed on the user devices that allows for document sharing (e.g., email or other message communication tool). The new document may then be opened by the other user using the Slide Show App.

In some examples, the other application that may be used for file sharing may be a default document sharing program selected by the user or the enterprise associated with the monitored users. In some examples, the document sharing program may be selected by the monitoring module 104 based on identifying that the user sharing access to the document has used the program to share documents before, or based on identifying that several users monitored by monitoring modules of the document recommendation system 100 most often use that program to share documents.

In some examples, rather than determining that users corresponding to the user IDs Bob Foo 301 and John Doe 303 want to collaborate with one another and providing document suggestions for collaboration to both users, the monitoring module may identify a particular user who may wish to share access to documents with another user or with a group of other users. This may occur, for instance, when the remote video conferencing program has indicated that one user is a moderator or leader of the remote video conference to which the other users are parties, or based on one user selecting a “share” button during the remote video conference call. The document recommendation system may thereafter identify the node of the knowledge graph that is commonly associated with all users who are parties to the remote video conference call, and may provide the prompt to share access to the document identified by the common node to the user who selected the “share” button.

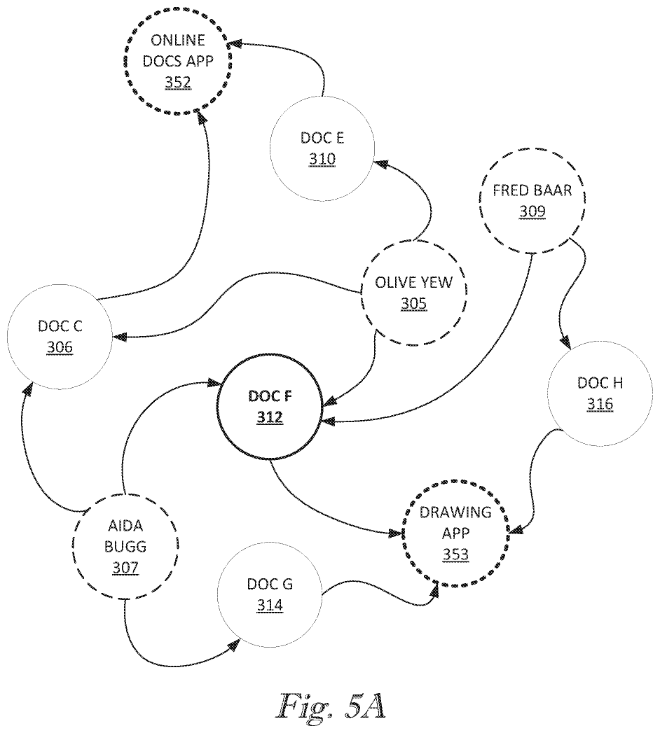

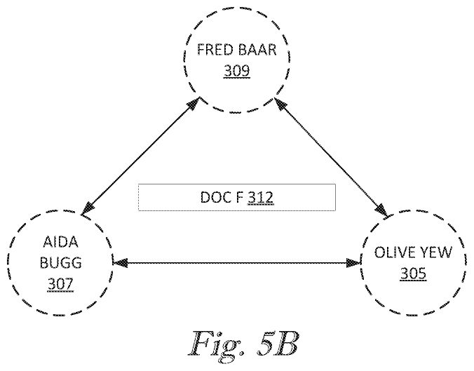

FIGS. 5A and 5B illustrate an example of a document recommendation system utilizing the knowledge graph of FIG. 3 to provide a document suggestion to three collaborating users, in accordance with an example of the present disclosure. The document recommendation system of FIGS. 5A and 5B may be the document recommendation system 100 of FIGS. 1, 2, 3, 4A, and 4B. The knowledge graph of FIG. 5A may be the knowledge graph 113 of FIGS. 1 and 3.

In the example of FIGS. 5A and 5B, users Aida Bugg, Fred Baar, and Olive Yew have initiated a remote video conference call using a remote video conference calling application, such as the one described above with respect to FIGS. 4A and 4B. The monitoring modules 104A-C of the document recommendation client applications 102A-C installed on the user devices 101A-C of these user may determine that these users want to collaborate together based on identifying that they have initiated a remote video conference call with one another.

Based on determining that these users want to collaborate with one another, the document recommendation system 100 may perform a search of the knowledge graph 113 to find a node commonly associated with user nodes Aida Bugg 307, Fred Baar 309, and Olive Yew 305. As seen in FIG. 5A, DOC F 312 is a document node representing a document previously accessed by Aida Bugg, Fred Baar, and Olive Yew that was created by an application represented by the application node Drawing App 353.

As shown in FIG. 5B, the document recommendation system 100 may then cause a prompt to be provided to Aida Bugg, Fred Baar, and/or Olive Yew to share access to DOC F with each of the other users. In some examples, although it may be determined that all users in a group of users want to collaborate together, a subset of the users of the group may be the users provided with prompts to share access to particular documents, based on the timestamps indicated by the edges connecting the user nodes of those particular users to the document nodes of those particular documents.

For example, if the timestamps of the edges of the knowledge graph 113 indicate that Fred Baar last accessed DOC F two years ago but Aida Bugg an Olive Yew both accessed the document within the past week, this may indicate that Fred Baar may not be very familiar with the recent modifications made to DOC F but that Aida Bugg and Olive Yew may have been collaborating on DOC F recently. Based on this information indicated by these timestamps, Aida Bugg and Olive Yew may be provided with the prompt to provide access to each of the other two respective users, but Fred Baar may not receive a prompt to share access to DOC F.

In some examples, the user input indicating that Aida Bugg, Fred Baar, and Olive Yew want to collaborate may have come from a single user, such as when Aida Bugg provides user input of hovering her mouse over an “attachment” button visible within a draft email that Aida Bugg is composing in a given email program and that includes Olive Yew and Fred Baar in the “To:” field. In such an example, it may be determined that Aida Bugg wants to collaborate with Fred Baar and Olive Yew. Based on this determination, the prompt suggesting sharing access to DOC F may be provided to Aida Bugg.

In some examples, more than one document may be provided as a suggested document to a user for sharing based on identifying more than one node commonly associated with all the users determined to be participating in the collaboration. For example, if, in the knowledge graph 113 of FIG. 5A, Fred Baar 309 was also associated with the DOC E 310 node, then the suggestion made to Aida Bugg, Fred Baar, and Olive Yew illustrated in FIG. 5B may list both DOC E and DOC F documents for sharing. In such examples, the users may select whether or not to share each listed document, or to share none.

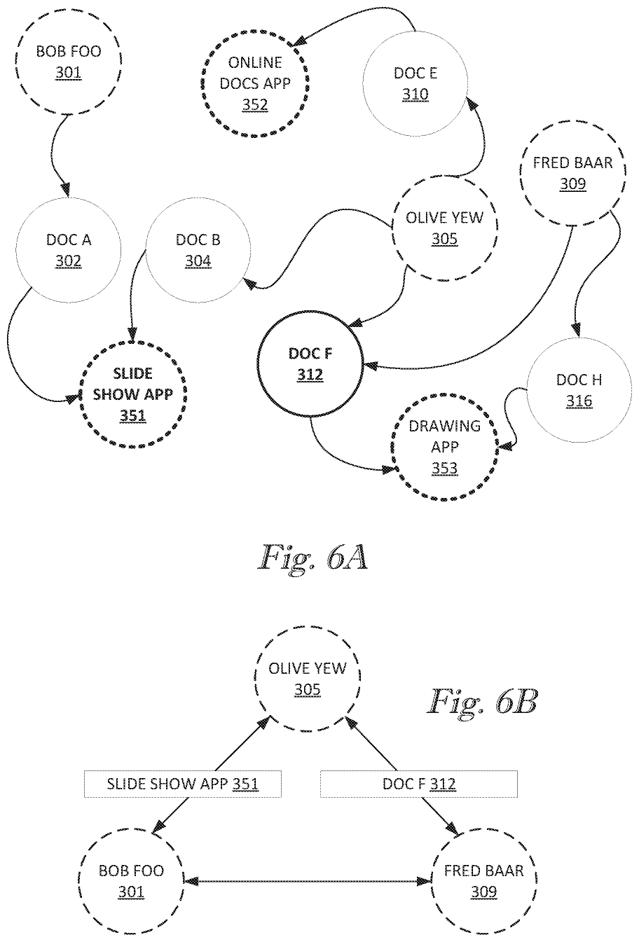

FIGS. 6A and 6B illustrate an example of a document recommendation system utilizing the knowledge graph of FIG. 3 to provide multiple document suggestions to three collaborating users, in accordance with an example of the present disclosure. The document recommendation system of FIGS. 6A and 6B may be the document recommendation system 100 of FIGS. 1, 2, 3, 4A, 4B, 5A, and 5B. The knowledge graph of FIGS. 6A and 6B may be the knowledge graph 113 of FIGS. 1 and 3.

In the example of FIGS. 6A and 6B, monitoring modules 104A-C may determine that the users Bob Foo, Olive Yew, and Fred Baar wish to collaborate based on, for example, determining that they have all initiated a remote video conference with one another using a monitored remote video conferencing program. In response to this determination, the document recommendation system 100 may search the knowledge graph 113 of FIG. 6A to for nodes commonly associated with the user nodes of all three users. As can be seen in FIG. 6A, there are no document nor document access program nodes that are commonly associated with the user nodes Bob Foo 301, Olive Yew 305, and Fred Baar 309.

When the document recommendation system 100 determines that there are no document nor document access program nodes that are commonly associated with the user nodes Bob Foo 301, Olive Yew 305, and Fred Baar 309, the document recommendation system may then attempt to find document or document access program nodes commonly associated with subsets of the group of users. Identifying documents and document access programs commonly associated with subsets of the group of users wanting to collaborate together may enable the document recommendation system to suggest documents that are likely to be relevant to the collaboration of the group of users, even if they are not commonly associated with the entire group of users in the knowledge graph.

As shown in FIG. 6A, the Olive Yew 305 and Fred Baar 309 nodes are both associated with the DOC F 312 node. The Olive Yew 305 and Bob Foo 301 nodes are not both associated with any common document node, but they are each associated with documents that are indicated as being created in the program represented by the Slide Show App 351 node. The Bob Foo 301 and Fred Baar 309 nodes are not both associated with any common document node, and they are also not both connected to any single document access program node through intermediary document nodes.

Based on identifying these connections in the knowledge graph, the document recommendation system 100, as shown in FIG. 6B, can provide prompts to Olive Yew to share access to DOC F and/or to a new document created using the Slide Show App with both Bob Foo and Fred Baar. In some examples, Bob Foo will also receive a prompt to share access to a new document created using the Slide Show App with Olive Yew and Fred Baar, and Fred Baar will also receive a prompt to share access to DOC F with Olive Yew and Bob Foo.

The document recommendation system 100 may determine to provide the prompt to Olive Yew based on her user node Olive Yew 305 being the common connection between the other user nodes, Bob Foo 301 and Fred Baar 309, in the knowledge graph. In some examples, however, all users within a subset of the group of users that are commonly associated with a document will be prompted to share access to that document with all of the users of the group who are determined to be collaborating.

If, in the situation of FIG. 6B, Olive Yew elects to share access to DOC F with both Bob Foo and Fred Baar, then both Bob Foo and Fred Baar will receive a copy of DOC F or a link to DOC F. Once Bob Foo and Fred Baar access the copies or links, the knowledge graph 113 of FIG. 6A will be updated based on metadata received from monitoring modules of their respective user devices indicating there is a new common association between Olive Yew, Bob Foo, Fred Baar, and DOC F based on all three users having previously accessed DOC F. The knowledge graph 113 may thus be updated to indicate this new common association. Subsequently, if the three users are indicated as wishing to collaborate again, DOC F may be the document suggested by the document recommendation system based on DOC F 312 being the document node commonly associated with Bob Foo 301, Olive Yew 305, and Fred Baar 309.

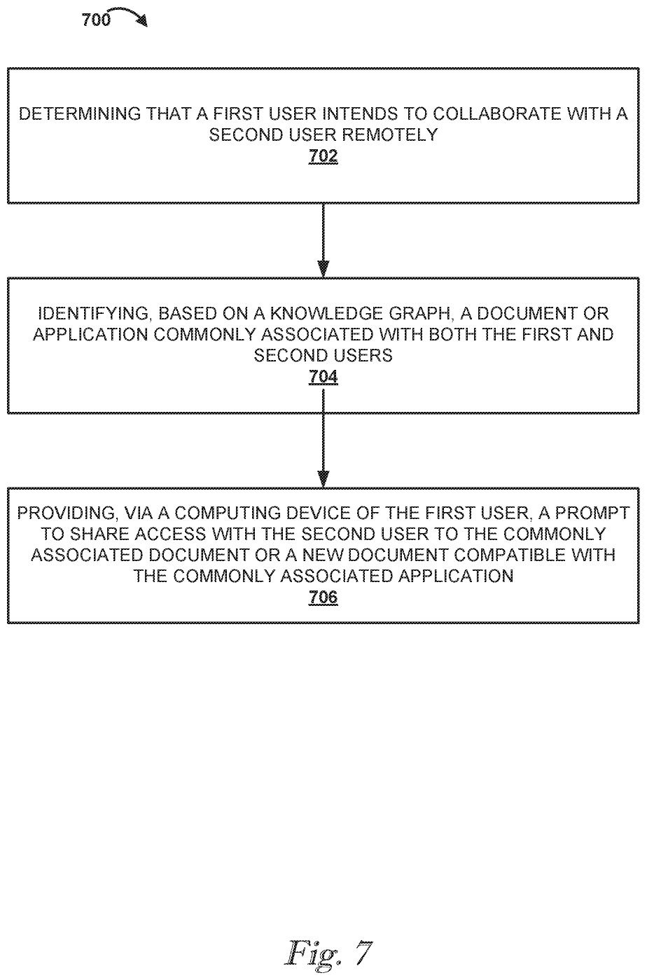

FIG. 7 is a flow diagram that illustrates an example method 700 for identifying a document commonly associated with a first user and a second user and providing a prompt to a first user to share access to the document with the second user, in accordance with an example of the present disclosure. Method 700 may be implemented by various computing devices together forming a document recommendation system, such as document recommendation system 100, as described herein.

Method 700 may begin with determining that a first user intends to collaborate with a second user remotely 702. As disclosed herein, document recommendation client applications of a document recommendation system that are associated with user devices of a first user and a second user can monitor usage of particular applications installed on or accessible from the user devices in order to determine that a first user intends to collaborate with a second user remotely. For example, document recommendation client applications associated with a first user device of the first user and with a second user device of a second user may observe that the first user and the second user are currently engaged in a remote video conference via a monitored remote video conference application installed on their user devices. The document recommendation client application associated with the first user device of the first user may further observe that the first user has selected or hovered their mouse over a “share” or “attach files” button. Based on determining that the first user and the second user are participating in a remote video conference together, and based on identifying the user input of the first user that indicates a desire to share documents with the second user, the document recommendation system may determine that the first user intends to collaborate with the second user remotely 702.

Based on determining that the first user intends to collaborate with the second user remotely at 702, a document or application commonly associated with both the first and second users is identified based on the knowledge in a knowledge graph 704. The document recommendation system may determine user identifiers associated with the first user and the second user. The document recommendation system may then search the knowledge of a knowledge graph that defines relationships between users, documents, and applications used to create documents observed by the document recommendation system.

The knowledge graph may be organized such that user nodes corresponding to user identifiers are connected to document nodes corresponding to identifiers of documents that those users have accessed by a first set of edges that indicate timestamps of when the user access occurred. The document nodes may also be connected by a second set of edges to application nodes corresponding to identifiers of applications used to create and usable to open those documents. Thus, the document recommendation system can identify user nodes corresponding to the first and second users, and then follow the connections of the knowledge graph to locate a document or application node that connects the two user nodes. The document recommendation system can then identify the document or application whose identifier corresponds to the connecting document or application node as being commonly associated with both the first and second users in the knowledge graph.

As discussed herein, the document recommendation system may first attempt to identify a document node connecting the first user and the second user. When the attempting fails due to there being no document node commonly associated with both the first and second users, the document recommendation system may then attempt to identify an application node that connects the first and second users through intermediary document nodes.

At 706, in response to identifying the document or application commonly associated with both the first and second users, the document recommendation system may provide, via a computing device of the first user, a prompt to share access with the second user to the commonly associated document or to a new document compatible with the commonly associated application. The first user selecting to share access to a document with the second user, responsive to the prompt, will cause the document or a link to the document to be sent to the user device of the second user. The sharing of documents or links may occur through the document recommendation client application, the monitored application through which the users are collaborating (if it supports such features), or through a document sharing application selected by the user.

When the first user shares access to the commonly associated document with the second user, the commonly associated document may be automatically opened via the user device of the first user. As a consequence, the edge connecting the node representing the first user to the node representing the commonly associated document may be updated to include a timestamp indicating when the first user selected to share access to the commonly associated document with the second user. When the second user receives the document or the link to the document and selects the link or opens the document, the edge connecting the node representing the second user to the node representing the commonly associated document may be updated to include a timestamp indicating when the second user accessed the document.

If the first user selects to share a new document compatible with an application commonly associated with both the first and second users, then the document recommendation system may generate a new document using the commonly associated application, share the new document with the second user, and update the knowledge graph accordingly. This may include adding a new node to the knowledge graph representing the new document and adding edges connecting the new document to the first user, the second user, and the commonly associated application. This may additionally include incorporating timestamps into the edges connecting the first user and the second user to the new document node based on the date and time that they select to share the new document and when they open the new document, respectively.

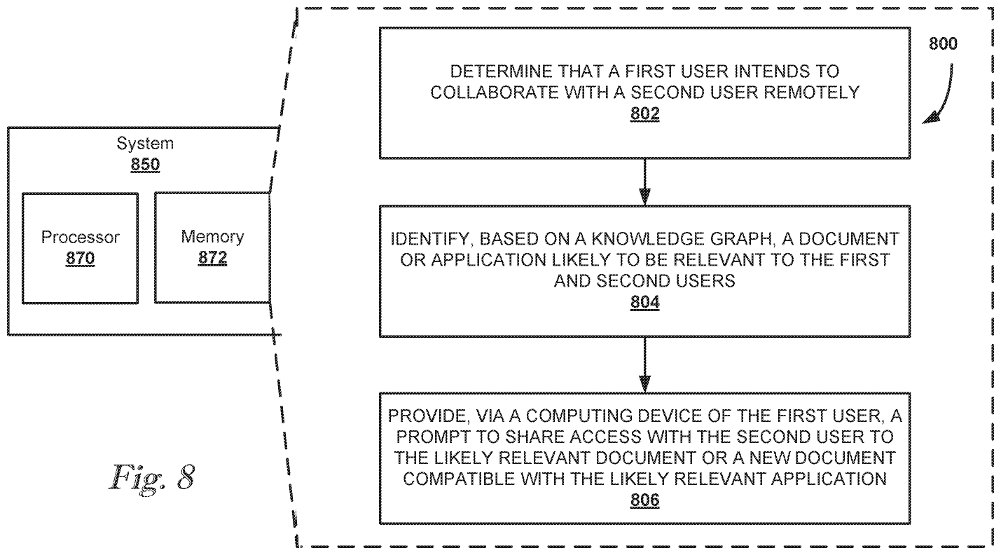

FIG. 8 illustrates an example system 850 performing an example process 800, in accordance with an example of the present disclosure. The system of FIG. 8 includes a processor 870 and memory 872 storing instructions that, when executed, perform the process 800. Process 800 may be performed by a document recommendation system, such as document recommendation system 100, including a server and various user devices as described herein.

Process 800 begins with determining that a first user intends to collaborate with a second user remotely 802. The document recommendation system may determine that a first user intends to collaborate remotely with a second user based on user input of the first user. The document recommendation system may monitor user input of monitored users within certain monitored applications on the user devices. In this way, the document recommendation system can determine when the first user has provided user input indicating an intent to share a document with second user.

For example, the first user may have authored a draft email indicating the second user in the “To:” field. The first user may further have hovered their mouse over or selected an “attachment” button visible within the draft email authoring window of the email application. Based on these user inputs, the document recommendation system may determine that the first user intends to collaborate with the second user remotely.

At 804, the document recommendation system can access the knowledge stored in the knowledge graph to identify a document or application that is likely to be relevant to the first user and the second user. The knowledge graph of FIG. 8 may be similar to the knowledge graph as described with respect to any of FIGS. 1, 2, 3, 4A, 4B, 5A, 5B, 6A, and 6B.

In some examples, the knowledge graph as discussed herein with respect to FIG. 8 may indicate a likely relevance of a document to a user rather than a mere happenstance association with a user. In these examples, the knowledge graph may be updated to show an association of a user with a document when that user created or modified that document, but not if the user merely viewed or shared that document. In some examples, edges connecting the user nodes to the document nodes within the knowledge graph may include metadata indicating the type of access that occurred at the time of the timestamp.

A document may be determined to likely be relevant to a user when a user node representing that user is connected to a document node representing that document by an edge that includes a timestamp. An application may be determined to likely be relevant to a user when a user node representing that user is connected to an application node representing that application through a document node representing a document compatible with that application, where the edge connecting the user node to the document node includes a timestamp.

In some examples, the metadata used to update the knowledge graph may indicate the likely relevance of a document or document access program to a user. In these examples, the likely relevance of a document or application to a user or group of users may be determined based on the dates and times of the timestamps and/or the types of user access indicated by the edges connecting the user nodes to terminal or connecting document nodes.

In some examples, a document or an application associated with a document may be determined to be relevant to both a first user and a second user based on the edges connecting their user nodes to a given document node or to a given application node though connecting document nodes having one timestamp indicating access within a threshold period of time, having both timestamps indicating access of both users occurring within a threshold period of time, having an access type designation indicating one user created the document, having both access type designations indicating both users modified the document, or any combination of these circumstances.

In examples where document creation and modification trigger updates to the knowledge graph but document viewing and/or sharing do not, the connections between the user nodes and a commonly associated document or application node, may be enough of an indication of likely relevance for the document recommendation system to determine the commonly associated document or application node corresponds to a document or application likely relevant to the group of users, without considering any timestamp indications or access type designations included in the connections.

In response to the document recommendation system identifying a document or an application that is likely relevant to the first user and the second user based on the knowledge in the knowledge graph, the document recommendation system can provide a prompt to the user device of the first user for the first user to share access to the likely relevant document or to a new document compatible with the likely relevant application at 806. When the first user selects to share access to a new document compatible with the likely relevant application, the document recommendation system generates a new document using the likely relevant application.

As described previously, the document may be shared with the second user through the document recommendation client applications, through a user-selected document-sharing application, or through a default document-sharing application as designated by the document recommendation system. In some examples, the knowledge graph may then be updated based on the first user's sharing of access to the document, based on the second user's opening and viewing of the shared document, and, when it is a new document that is shared, based on the creation of the new document using the likely relevant application.

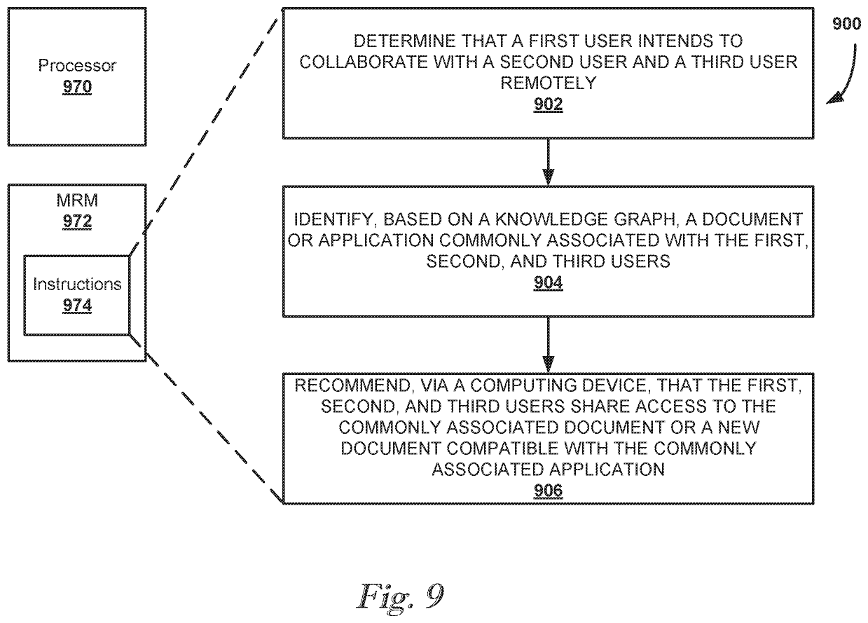

FIG. 9 schematically depicts an example non-transitory machine readable medium 972 with a processor 970, in accordance with an example of the present disclosure. The machine-readable medium 972 may include instructions 974 which, when executed by the processor 970, cause the processor to perform document recommendation process 900.

Document recommendation process 900 begins at 902 with determining that a first user intends to collaborate with a second and third user remotely. This determination may be made based on data collected from the user devices of the first, second, and third users. For example, data of the user devices of the first, second, and third users may indicate that the first, second, and third users have initiated a remote video conference with one another via a remote video conferencing application installed on their user devices.

Based on these indications provided by the data of the user computing devices, it may be determined that a first user intends to collaborate with a second and third user. In response to determining that the first user intends to collaborate with the second user and the third user, a document or application commonly associated with the first, second, and third users may be identified at 904 based on searching a knowledge graph describing user associations with documents and document access programs, as described herein.

In response to identifying the document or application commonly associated with the first user, the second user, and the third user, document recommendation process 900 may cause a computing device to recommend that the first, second, and third users share access to the commonly associated document or a new document associated with the commonly associated application. In some examples, the computing device may be the user device of the first, second, or third user. In some examples, the computing device may be a server in communication with the user devices of the first, second, and third users and causing the computing device to recommend the first, second, and, third users share access to the commonly associated document or a new document compatible with the commonly associated application may include causing the server to communicate with an application installed on the user devices of the users to provide a prompt to some or all of the users to share the access, as described herein.

In some examples, the document recommendation system described herein may use the knowledge graph to recommend a user initiate collaboration with other users on a given document. Thus, the document recommendation system may also act as a collaborator recommendation system. In such examples, a monitoring module of the document/collaborator recommendation system that is local to the user device may observe that a user is accessing a particular document using a monitored document access program. Based on this observation, the monitoring module may generate metadata including the user's user identifier and the document's document identifier. The monitoring module may provide this metadata to a knowledge module also local to the user device.

When the knowledge module receives the generated metadata, it may form a request to provide, through an API, to a remote knowledge collection entity hosting a knowledge graph. The knowledge graph may indicate user interactions with documents and document access programs as described herein. The knowledge collection entity may search the knowledge graph to locate user nodes corresponding to other users who have previously worked on the document that corresponds to the document identifier. The document/collaborator recommendation system may then provide a prompt to the user to initiate collaboration on the document with the identified other users.

The user initiating collaboration based on responding affirmatively to the prompt may include the document collaborator recommendation system initiating a remote video conference with the user and identified other users as participants or causing a calendar or email application to send a meeting request from the user to the identified other users. In some examples, the document/collaborator recommendation system may be triggered to prompt the user to collaborate with the identified other users after the user has saved and/or closed the newly modified document. In these examples, the user initiating collaboration based on responding affirmatively to the prompt may include the document collaborator recommendation system sending a copy of or a link to the newly modified document to the identified other users. This may occur through their respective document/collaborator recommendation client applications installed locally on their devices, or may occur through another document access program capable of sharing documents.

It shall be recognized, in light of the description provided, that the elements and procedures described above may be implemented in a computer environment using hardware, computer-readable instructions, firmware, and/or combinations of these. Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A method implemented using a processor, comprising:
determining based on input provided by a first user, that the first user intends to collaborate with a second user remotely;
identifying, based on a knowledge graph that defines relationships between users, documents, and applications usable to open the documents, a document or application that is commonly associated with both the first user and the second user; and
providing, via a computing device of the first user, a prompt to share access with the second user to the commonly associated document or a new document compatible with the commonly associated application.

2. The method of claim 1, comprising in response to determining that the second user opened or manipulated the commonly associated document or the new document, updating the knowledge graph to indicate a new common association between the commonly associated document or new document, the first user, and the second user.

3. The method of claim 1, further comprising:
monitoring, for a plurality of users, instances of access to a plurality of documents, each of the instances of access comprising a user: opening a document, modifying a document, or sending or receiving an electronic communication including a document as an attachment;
determining, based on the monitoring, that particular users have accessed respective documents;
generating metadata indicating associations between each of the particular users and each of the respective documents they accessed; and
storing the metadata in the knowledge graph, wherein the stored metadata includes a timestamp describing when each of the particular users accessed each of the respective documents.

4. The method of claim 1, wherein the identifying comprises first attempting to identify a commonly associated document, and identifying the commonly associated application when the attempting fails.

5. The method of claim 4, wherein identifying the commonly associated application includes:
traversing the knowledge graph from a node representing the first user to a node representing a given document not previously opened or manipulated by the second user, wherein the commonly associated application is usable to open the given document;
determining from the knowledge graph that the second user previously opened another given document with the commonly associated application; and
providing the prompt to share access with the second user to the new document that is compatible with the commonly associated application.

6. The method of claim 1, wherein the identifying comprises determining that an electronic communication sent to the second user included the commonly associated document as an attachment.

7. The method of claim 1, wherein the knowledge graph includes:
a first set of edges that connect user nodes to document nodes; and
a second set of edges that connect document nodes to application nodes, wherein each edge of the second set identifies a document associated with the respective document node as being compatible with an application associated with the respective application node.

8. A system, comprising:
a processor; and
a memory device, the memory device storing instructions executable by the processor to cause the processor to:
determine based on input provided by a first user, that the first user intends to collaborate with a second user remotely;
identify, based on a knowledge graph that defines relevance of applications and documents to users, a document or application likely to be relevant to the first and second users; and
provide, via a computing device of the first user, a prompt to share access with the second user to the likely relevant document or a new document compatible with the likely relevant application.

9. The system of claim 8, comprising instructions to:
monitor, for a plurality of users, instances of access to a plurality of documents, wherein in each of the instances, a user: opens a document, modifies a document, or sends or receives an electronic communication including a document as an attachment or including a link to the document;
determine that particular users have accessed respective documents;
generate metadata indicative of a likely relevance of each of the respective documents to each of the particular users that accessed the respective documents; and
store the metadata in the knowledge graph, wherein the stored metadata includes a timestamp indicative of when each of the particular users accessed each of the respective documents.

10. The system of claim 9, comprising instructions to:
generate, for each new document whose access is shared with the second user, additional metadata indicative of:
a particular application used to create the new document, and
a likely relevance of the new document to the first user and the second user,
and
store the additional metadata in the knowledge graph, wherein the stored additional metadata includes a timestamp that indicates when the first user shared access to the new document with the second user.

11. The system of claim 10, comprising instructions to:
identify, based on the knowledge graph, a particular application used to:
create or modify a first given document indicated as likely relevant to the first user, wherein the first given document has not been previously accessed by the second user, and
create or modify a second given document indicated as likely relevant to the second user, wherein the second given document has not been previously accessed by the first user; and
determine, based on the timestamps and the particular application being used to create both the first given document indicated as likely relevant to the first user and the second given document indicated as likely relevant to the second user, that the particular application is likely relevant to the first and second users.

12. A non-transitory computer-readable medium containing instructions executable by a processor to cause the processor to:
determine, based on input provided by a first user, that the first user intends to collaborate with a second user and a third user remotely;
identify, based on a knowledge graph that defines edges between nodes corresponding to users, documents, and applications usable to open the documents, a document or application that is commonly associated with the first user, the second user, and the third user; and
recommend, via a computing device, that the first, second, and third users share access to the commonly associated document or a new document compatible with the commonly associated application.

13. The non-transitory computer-readable medium of claim 12, comprising instructions to:
monitor, for a plurality of users, instances of access to a plurality of documents, each of the instances of access comprising a user performing: open a document, modify a document, or send or receive an electronic communication including a document as an attachment;
determine that particular users have accessed respective documents;
generate an edge indicating an association between each of the respective documents to each of the particular users that accessed the respective documents; and
add the edges to the knowledge graph, wherein each edge includes a timestamp describing when each of the particular users accessed each of the respective documents.

14. The non-transitory computer-readable medium of claim 13, comprising instructions to:
identify, based on the knowledge graph, a particular document commonly associated with the first user and the third user;
identify, based on the knowledge graph, a particular application used to create a first given document indicated as associated with the first user and also used to create a second given document indicated as associated with the second user; and
provide, via the computing device of the first user, a prompt for the user to select the particular document, a new document compatible with the particular application, or both to which to share access with the second and third users.

15. The non-transitory computer-readable medium of claim 14, comprising instructions to:
determine, based on responsive user input of the first user provided based on the prompt, that the first user is sharing access to the new document with the second and third users; and
based on the first user sharing access to the new document with the second and third users:
generate additional metadata indicating a common association between the new document, the first user, the second user, and the third user; and
store the additional metadata in the knowledge graph, wherein the stored additional metadata includes a timestamp describing when the first user shared access to the new document with the second and third users.
